(19) United States
(12) Patent Application Publication
(10) Pub. No.: US 2012/0263433 A1
(43) Pub. Date: Oct. 18, 2012

(54) Detecting Key Roles and Their Relationships from Video

(75) Inventors: Tao Mei, Beijing (CN); Xian-Sheng Hua, Bellevue, WA (US); Shipeng Li, Palo Alto, CA (US); Yan Wang, New York, NY (US)

(73) Assignee: Microsoft Corporation, Redmond, WA (US)

(21) Appl. No.: 13/085,288

(22) Filed: Apr. 12, 2011

(51) Int. Cl. H04N 9/80

(52) U.S. Cl. 386/241; 386/E05.003

(57) ABSTRACT

Tools and techniques for acquiring key roles and their relationships from a video independent of metadata, such as cast lists and scripts, are described herein. These techniques include discovering key roles and their relationships by treating a video (e.g., a movie, television program, music video, and personal video, etc.) as a community. For instance, a video is segmented into a hierarchical structure that includes levels for scenes, shots, and key frames. In some implementations, the techniques include performing face detection and grouping on the detected key frames. In some implementations, the techniques include exploiting the key roles and their correlations in this video to discover a community. The discovered community provides for a wide variety of applications, including the automatic generation of visual summaries or video posters including acquired key roles.

### BACKGROUND

Promotional materials for videos are helpful in informing a potential audience about the content of the videos. For instance, video trailers, still-image posters, and the like may be helpful in letting users know about the theme or plot of a movie, television show, or other type of video. In order to create quality promotional materials, it is often useful to analyze the content of a particular video to determine the plot, key character roles within the video, and the like. With this information, the creator of the promotional material is able to create the trailer, poster, or other type of content in a way that adequately portrays the contents of the video.

Conventional approaches to movie content analysis depend on metadata provided by cast lists, scripts, and/or crowd-sourcing knowledge from the web without regard to correlations among roles. For instance, these traditional techniques may identify main characters from a video by manually identifying the characters and using metadata (e.g., cast lists, scripts, and/or crowd-sourcing knowledge from the web) associated with the movies. Some attempts have been made to associate names with the corresponding roles in news videos based on co-occurrence, as well as using face appearance, clothes appearance, speaking status, scripts, and image search results. One approach attempts to match an affinity network of faces and a second affinity network of names in order to assign a name to each face. However, such an approach has limited applicability for generating promotional posters since the matching merely matches faces to names.

While these traditional techniques may work in instances where the analyzed video includes rich metadata, such conventional approaches are not practical when little metadata is available, which may be true for internet protocol television (IPTV) and video on demand (VOD) systems. In contrast to metadata-rich videos, these videos often only include a brief title of each video section. In addition, the current process of creating promotional posters is time intensive and expensive because the current process requires the skills of graphics artists and designers. Promotional posters are characterized by: (1) having a conspicuous main theme and object; (2) grabbing attention through the use of colors and textures; (3) being self-contained and self-explained; and (4) being specially designed for viewing from a distance. Accordingly, as the amount of movies and other videos increase, manual techniques become difficult to effectively administer. In addition, not all of these movies and videos will have a sufficient amount of metadata available for analysis to create a high-quality poster or other types of promotional content.

### SUMMARY

Creating promotional posters for videos may be helpful for marketing these videos. Displaying the main characters from a video is a cornerstone for promotional posters in some instances. Tools and techniques for automatically acquiring key roles from a video free from use of metadata (e.g., cast lists, scripts, and/or crowd-sourcing knowledge from the web) are described herein.

These techniques include discovering key roles and their relationships by treating a video (e.g., a movie, television program, music video, personal video, etc.) as a community. First, the techniques segment a video into a hierarchical structure that includes levels for scenes, shots, and key frames. Second, the techniques perform face detection and grouping on the detected key frames. Third, the techniques exploit the key roles and their correlations in this video to discover a community. Fourth, the discovered community provides for a wide variety of applications, including the automatic generation of visual summaries (e.g., video posters) based on the acquired key roles.

This summary is provided to introduce concepts relating to acquiring and presenting key roles via community discovery from video. These techniques are further described below in the detailed description. This summary is not intended to identify essential features of the claimed subject matter, nor is it intended for use in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an example computing environment including a computing device that acquires key roles from video.

FIG. 2 illustrates example components for acquiring a key role from a video via community discovery.

FIG. 3 illustrates example components for determining a face cluster of a key role.

FIG. 4 illustrates an example excerpted from several face cluster results from a video.

FIG. 5 illustrates an example of a community graph discovered from key roles acquired from a video.

FIG. 6 illustrates example user interface (UI) presentations in the form of posters created using key roles acquired from a video.

FIGS. 7 and 8 are flow diagrams illustrating example approaches for acquiring key roles and their relationships from video for presentation.

FIG. 9 is a flow diagram of an example process for acquiring a key role via face grouping.

FIG. 10 is a flow diagram of an example process employing key-role acquisition from video to generate presentations.

### DETAILED DESCRIPTION

Promotional posters are helpful in marketing videos, and often display the main characters from a video. The techniques described below automatically create a presentation that includes images of the characters that are determined, automatically, to be the main characters in the video. These techniques may make this automatic determination by analyzing the video to determine how often each character appears in the video.

The techniques described herein identify key roles of a video by analyzing the video itself. That is, the techniques use facial recognition techniques to identify the main characters of a video. From this information, the techniques may then automatically create a visual presentation (e.g., a poster or other visual summary) for the video that includes the main characters.

The techniques may identify the main characters in any number of ways. For instance, the techniques may determine how often a face appears on screen, how often a character is spoken about, and the like. Furthermore, the techniques may create a community graph based on the analysis of the movie, which may also be used to identify the key roles. The community graph may depict the interrelationships between characters in the movie, as well as a strength of these interrelationships.

By discovering relationships within a community in this way, these example techniques are able to discover key roles within a video that is free from typically-used rich metadata, such as cast lists, scripts, and/or crowd-sourced information obtained from the world-wide-web. These techniques include automatically discovering key roles and their relationships by treating a video (e.g., a movie, television program, music video, personal video, etc.) as a community. First, the techniques segment a video into a hierarchical structure (including shot, key frame, and scene). Second, the techniques perform face detection and grouping on the detected key frames. Third, the techniques create a community by exploiting the key roles and their correlations or relationships in the video segments. Finally, the discovered community provides for a wide variety of applications. In particular, the discovered community enables automatic generation of visual summaries or video posters based on the acquired key roles from the community.

For context, the entertainment industry has boomed in recent years, resulting in a huge increase in the number of videos, such as movies, television programs, music videos, personal videos, and the like. As the numbers of videos grow, it becomes important to index and search video libraries. In addition, because people respond favorably to images, such as those in promotional posters, being able to present a pleasant visual summary is important for promotional purposes. As such, the techniques described herein may be helpful in creating a poster or other image that visually represents a respective video in a manner that is consistent with the content of the video.

Generally, characters of a video are the center of attention within the video, and the interactions among these characters help to narrate a story. Because these characters (or “roles”) and their interactions are the center of audience interest, indentifying key roles and analyzing their relationships to discover a community is useful for understanding the content of a movie or other video. However, discovering a community is challenging due to the complex environment in movies. For example, the variation of characters' poses, wardrobe changes, and various illumination conditions may make the identification of characters within a video difficult. In addition, correlations or relationships between roles are difficult to analyze thoroughly because roles can interact in different ways, including direct interactions (e.g., dialogs with each other) and indirect interactions (e.g., talking about other roles). Thus, being able to automatically acquire key roles for indexing, while useful, is not straightforward.

In order to automatically detect key roles from video, the techniques described below first structure the incoming video, whether the video is streaming or stored. The first structural unit that the techniques identify is a shot, which includes a continuous section of video shot by one camera. The second structural unit that the techniques identify is a key frame, which, as used herein, includes an image extracted from a shot that includes at least one face and that represents the shot in terms of color, background image, and/or action. In some implementations a key frame may include more than one image from a shot. This definition of a “key frame” may differ from traditional uses of the term “key frame” in some instances. The third structural unit that the techniques build is a scene, which include shots that are similar to one another and that the techniques groups together to form the scene. In various implementations, shot similarity is determined based on the shots having similarity to each other greater than a predetermined or configurable threshold value.

The techniques detect faces that appear in the key frames and groups the faces into face clusters according to role. The techniques then construct a community graph based on co-occurrence of the faces in the video. In the community graph, key roles are presented as nodes/vertices and relationships between the key roles are presented as edges.

Once discovered, the community graph of key roles has a wide variety of applications including automatic generation of visual summaries such as video posters, images to accompany reviews, or the like. In one specific example of many, the techniques described herein generate a visual summary (e.g., a movie poster) by detecting key roles from a discovered community, selecting representative images for each key role, selecting a typical background image of the video, and creating the poster according to at least one of four different visualization techniques based on the representative key roles and the background.

The discussion begins with a section entitled “Example Computing Environment,” which describes one non-limiting environment that may implement the described techniques. Next, a section entitled “Example Components” describes non-limiting components that may implement the described techniques in the example environment or other environments. A third section, entitled “Example Approach to Community Discovery from a Video” illustrates and describes one example technique for discovering community from a video without employing metadata. A fourth section, entitled “Example Video Poster Generation,” illustrates an example application for acquiring a key role and presenting the key role via community discovery from video. A fifth section, entitled “Example Processes,” presents several example processes for acquiring a key role and presenting the key role via community discovery from video. A brief conclusion ends the discussion.

This brief introduction, including section titles and corresponding summaries, is provided for the reader's convenience and is intended to limit neither the scope of the claims nor the following sections.

### Example Computing Environment

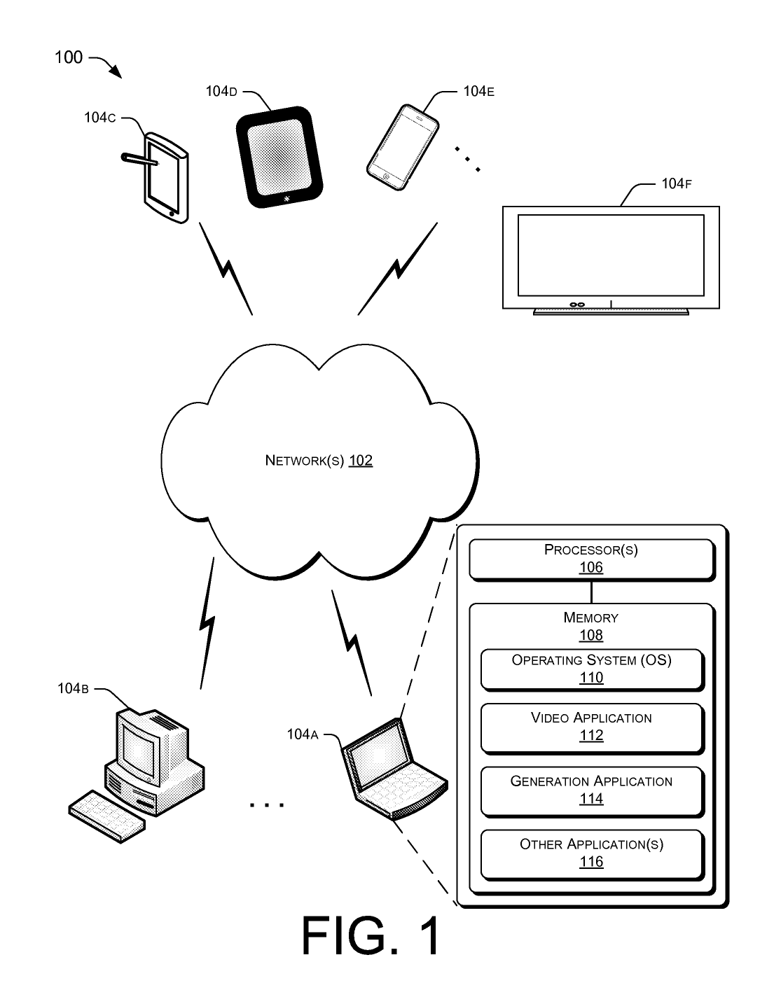

FIG. 1 illustrates an example computing environment 100 in which techniques for acquiring a key role and presenting the key role via community discovery from video independent of metadata may be implemented. The environment 100 includes a network 102 over which the video may be received by a computing device 104. The environment 100 may include a variety of computing devices 104 as video source and/or presentation destination devices. As illustrated, the computing device 104 includes one or more processors 106 and memory 108, which stores an operating system 110 and one or more applications including a video application 112, a generation application 114, and other applications 116 running thereon.

While FIG. 1 illustrates the computing device 104A as a laptop-style personal computer, other implementations may employ a personal computer 104B, a personal digital assistant (PDA) 104c, a thin client 104D, a mobile telephone 104E, a portable music player, a game-type console (such as Microsoft Corporation's Xbox™ game console), a television with an integrated set-top box 104F or a separate set-top box, or any other sort of suitable computing device or architecture. When the computing device 104 is embodied in a television or a set-top box, the device may be connected to a head-end or the internet, or may receive programming via a broadcast or satellite connection.

The memory 108, meanwhile, may include computer-readable storage media. Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The applications 112, 114, and 116 may represent desktop applications, web applications provided over a network 102, and/or any other type of application capable of running on the computing device 104. The network 102, meanwhile, is representative of any one or combination of multiple different types of networks, interconnected with each other and functioning as a single large network (e.g., the Internet or an intranet). The network 102 may include wire-based networks (e.g., cable) and wireless networks (e.g., cellular, satellite, etc.).

As illustrated, the computing device 104 implements a video application 112 that functions to structure streaming or stored video for acquiring a key role and community discovery for presentation from a generation application 114. In other implementations the generation application 114 may be integrated in the video application 112.

### Example Components

Various components may be employed to automatically generate video presentations by acquiring key roles from the video without employing rich metadata. In at least one instance, the described components discover a community to represent the video. The components then use the community to determine the key roles, which the components then use to create a poster or other type of promotional material that accurately portrays the contents of the video. For instance, the poster may include images of the key roles identified with reference to the discovered community.

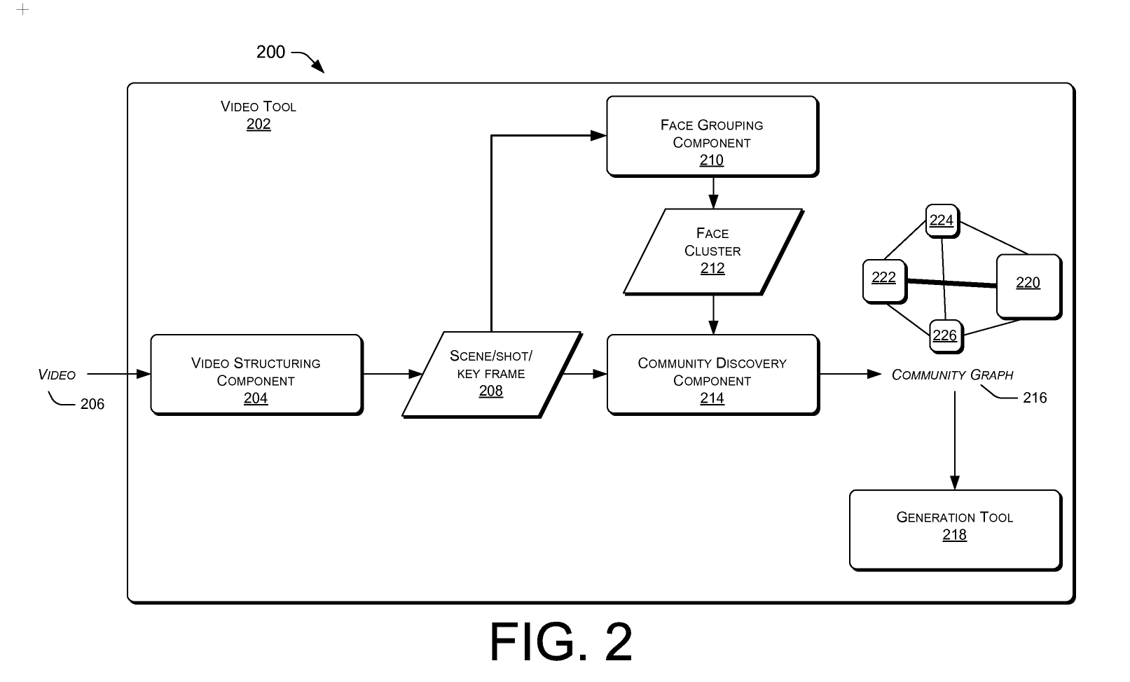

FIG. 2, for instance, illustrates example components for discovering a community from a video to acquire key roles independent of rich metadata such as cast lists and scripts at 200. The described approach includes discovering key roles and their relationships based on content analysis.

As shown in FIG. 2, a video tool 202 (e.g., which may include the video application 112 or similar logic) includes a video structuring component 204 that receives a video 206. In response, the video structuring component 204 analyzes and segments the video into hierarchical levels. The video structuring component 204 then outputs the video structure information 208 as hierarchically structured levels that include scenes, shots, and key frames for further processing by other components included in the video tool 202.

A face grouping component 210, in the illustrated instance, detects faces from the key frames and performs face grouping to output a face cluster 212 for each role in the video. Based on the roles represented by each face cluster 212 and the video structure information 208, the community discovery component 214 identifies nodes (e.g., according to co-occurrence of the roles in a scene) and constructs a community graph 216. The community graph 216 is input to the generation tool 218, which in FIG. 2 is shown integrated in the video tool 202. In other implementations, for example as shown in the environment of FIG. 1, the generation tool 218 may be separate from and operate independently of the video tool 202.

In a community graph 216, each node represents a key role within the video and the weight of each edge indicates a significance of the relationship between each pair of roles. In some instances the size of particular nodes in the community graph 216, corresponds to how “key” the community discovery component 214 determines the role is in the community.

In the illustrated example of community graph 216, the four illustrated roles are identified as most important based on their interactions, although any number of roles may make up the community graph 216 in other instances. In this example, a node 220 represents the most key role, while a node 222 represents the next most key role, and the nodes 224 and 226 represent other key roles that interact with the roles represented by the nodes 220 and 222, but appear less often in the video. Accordingly, the nodes 220 and 222 likely represent characters played by the stars of the video while the nodes 224 and 226 likely represent major supporting roles.

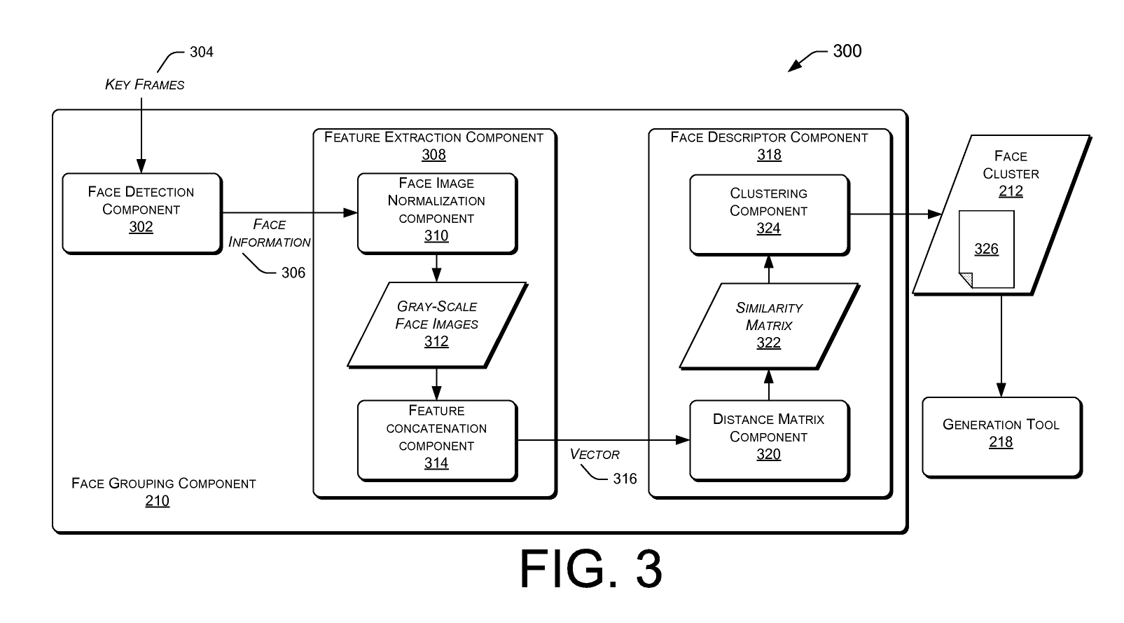

FIG. 3 illustrates, at 300, example components for determining a face cluster 212. As shown at 300, the face grouping component 210 includes a face detection component 302 that receives one or more key frames 304, such as from the structured video 208. The face detection component 302 detects faces from the key frames 304 to get the face information 306 and includes bounding face rectangles as face images. The face detection component 302 may detect multiple face areas from each key frame 304, in some instances, since a video can contain a large number of characters per shot. Based on face images detected from each face area, the face grouping component 210 groups each face image detected to be the same person together to form several groups. The higher number of face images per group, the more often the detected face appears in shots of the video.

A feature extraction component 308 extracts features from the face information 306. The feature extraction component 308 includes a face image normalization component 310 that normalizes the detected faces into (e.g., 64×64) gray scale images 312. A feature concatenation component 314 concatenates the gray value of each pixel as a 4096-dimensional vector 316 for each detected face image, in some instances.

A face descriptor component 318 creates a description for each detected face image based on the vector 316. The face descriptor component 318 includes a distance matrix component 320 that receives each vector 316 and compares the vectors using learning based encoding and principal component analysis (LE-PCA) to produce a similarity matrix 322. A clustering component 324 then takes similarity matrix 322 as input and outputs a face cluster 212 with an exemplar 326 for each cluster, which is used by generation tool 218. In various implementations, clustering component 324 employs an Affinity Propagation (AP) clustering algorithm. However, in other implementations a K-Means or other clustering algorithm may be employed. In some instances the exemplar 326 is a face image that is first identified as belonging to the face cluster 212. Although, in other instances, the exemplar 326 is selected based on other or additional criteria such as having a forward facing pose or the illumination conditions of the particular face image. The exemplar 326 is used as the node representation in community graph 216 in some implementations.

Example Approach to Community Discovery from a Video

Various approaches may be employed to automatically generate video presentations by acquiring key roles from a video without employing rich metadata. One such approach includes discovering a community to represent the video. The described approach includes automatically identifying key roles and their relationships based on video content analysis without employing metadata. The approach includes identifying key roles from the video. Key roles are those characters, identified by the faces that appear most often in the video. The faces that appear most often are likely to represent the main characters of the video. Once the key roles are identified, the approach discovers a community based on relationships between the identified roles.

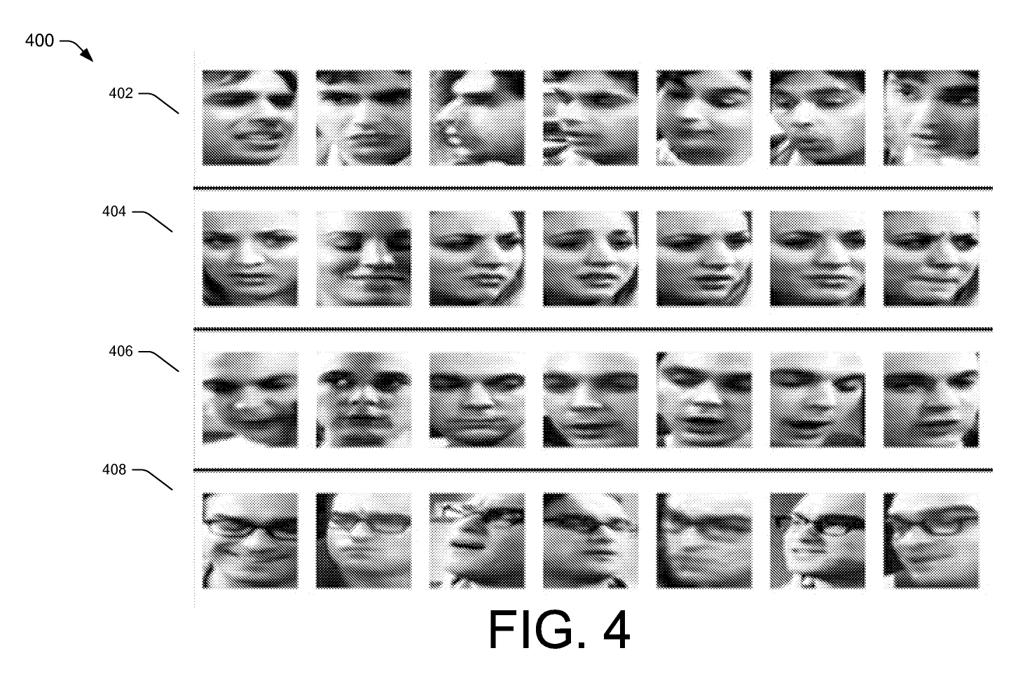

FIG. 4 illustrates, at 400, example face images excerpted from several face clusters 212 from a video. Each of rows 402, 404, 406, and 408 represent a respective four clusters and include seven images from the respective four clusters. The number of images per cluster will vary per video and per role. For each cluster in FIG. 4, the similarity of each two vectors representing each face image is calculated using their Euclidean distance. To obtain clusters as exemplified in FIG. 4, the clustering component 324 iteratively calculates an exemplar for each cluster starting by initially treating each of n face images, [symbol] ={fᵢ}ᵢ₌₁ⁿ, as a potential exemplar of itself. The clustering component 324 propagates two types of information for each pair fᵢ and fⱼ. The first type of information propagates from fᵢ to fⱼ and indicates how well fⱼ would serve as an exemplar of among all of the potential exemplars of fᵢ. The first type of information is termed responsibility and denoted r(i, j). The second type of information propagates from fⱼ to fᵢ and indicates how appropriately fⱼ would act as an exemplar of fᵢ by considering other potential representative face images that may choose fⱼ as an exemplar. The second type of information is termed availability and denoted a(i, j).

Given a similarity matrix S_{n×n}={S_{i,j}|s_{i,j} is similarity between fᵢ and fⱼ}, such as a similarity matrix 322, the two types of information are propagated iteratively as shown in equation 1, below.

r(i,j)←S_{i,j}−max_{j≠j′}{A(i,j′)+s_{i,j′}}

a(i,j)←min{0,r(j,j)}+Σ_{i′∉{i,j}}max{0,r(i′,j)} (1)

Self availability is determined by equation 2, below.

a(j,j)←Σ_{i′≠j} max{0,r(i′,j)} (2)

The iteration process stops when convergence is reached, and the exemplar for each face fᵢ is extracted by solving equation 3, presented below.

arg maxⱼ{r(i,j)+a(j,j)} (3)

The clustering component 324 clusters faces with the same exemplar 326 as a face cluster 212, for example as shown in the excerpted rows 402, 404, 406, and 408 with each cluster containing the images of one role as shown in the excerpts.

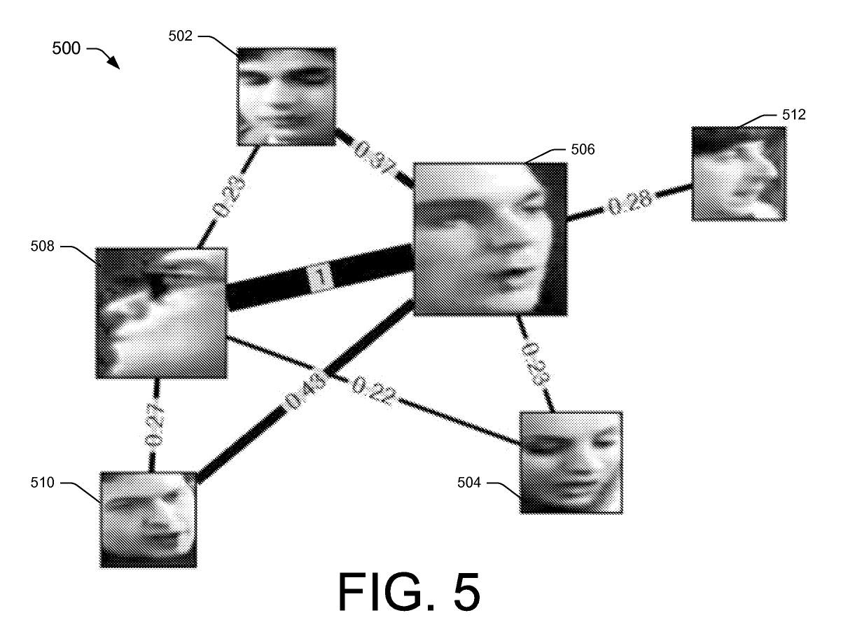

FIG. 5 illustrates, at 500, an example of a community graph, such as community graph 216. In this example, the community graph 500 is discovered from key roles identified from face clusters generated from the same video as the cluster excerpts shown in FIG. 4.

The nodes 502, 504, 506, and 508 of FIG. 5 are exemplars that correspond to the clusters of FIGS. 4, 402, 404, 406, and 408, respectively. Meanwhile, the nodes 510 and 512 are exemplars from clusters that were omitted from the sample presented in FIG. 4 in the interest of brevity.

The community graph 500 depicts interactions among roles in a video using social network analysis, which is a field of research in sociology that models interactions among people as a complex network among entities and seeks to discover hidden properties. In the community graph 500, people or roles are represented by nodes/vertices in a social network, while correlations or relationships among the roles are modeled as weighted edges. Because characters in videos interact in different ways such as through physical contact, verbal interaction, appearing together in frames of the video, and speaking about other characters that are not in the current frame, a community graph may use various correlations.

In the example of the community graph 500, the community discovery component 214 uses a “visually accompanying” correlation for roles that co-occur in a scene. In other examples one or more different correlations such as “physical contact” and “verbal interaction” may be used.

Specifically, the “visually accompanying” correlation means that when two roles appear in the scene, they need not appear together in a frame in order to have the “visually accompanying” correlation. Roles appearing closer together in a time line of the scene indicate a stronger relationship in accordance with the “visually accompanying” correlation. According to the analysis performed by the community discovery component 214, correlations d(a, b) between two faces a and b are represented by equation 4, in which c is a constant in seconds and ΔT=|time (a)−time (b)| measures the temporal distance of the two faces a and b.

$$d ( a , b ) = \{ \begin{matrix}c \text{/} ( 1 + Δ T ) & when face a and face b are in the same scene \\ 0 & otherwise\end{matrix} \qquad ( 4 )$$

The community discovery component 214 collects correlations or relationships of all of the faces from each detected role and calculates the weight of the edge between each face cluster A and B in the graph to obtain an adjacency matrix W_{A,B} in accordance with equation 5.

W_{A,B}=w(A,B)=Σ_{a∈A}Σ_{b∈B}d(a,b) (5)

For example, the face detection component 302 often detects around 500 faces from key frames of two hours of video. Thus, the community discovery component 214 calculates d(a, b) about C₅₀₀²≈10⁵ times for such a two-hour video.

In at least one implementation, face pair correlations d(a, b) are calculated scene by scene. Although in other implementations face pair correlations d(a, b) may be calculated on a per video basis or across multiple videos, for example in the case of a television or movie series.

The community graph 500 includes nodes of differing sizes that illustrate the size of the corresponding face cluster. For example, the node 506 being larger than the other nodes indicates that the cluster 406 includes more face images than the other clusters for the example video. In addition, the weights of the edges between the nodes illustrate the strength of the correlation. Although FIG. 5 shows the weights both numerically and graphically by the width of the edge line, both need not be shown.

A parameter can be set in various implementations to control a minimum strength of correlation as well as a number or percentage of roles/nodes to be included in a community graph 216, such as the graph 500. Configurable parameter entries may result in the top configurable amount or percentage of identified key roles with correlation weights above a configurable amount or percentage being included in the community graph. While other parameter entries may result in the top 5 or 25% of identified key roles with the highest 25% of correlation weights or weights of 0.2 or higher being included in the community graph. In some instances all nodes connected by edges with the threshold correlation weight are illustrated, and other parameter entries may be included.

### Example Video Poster Generation

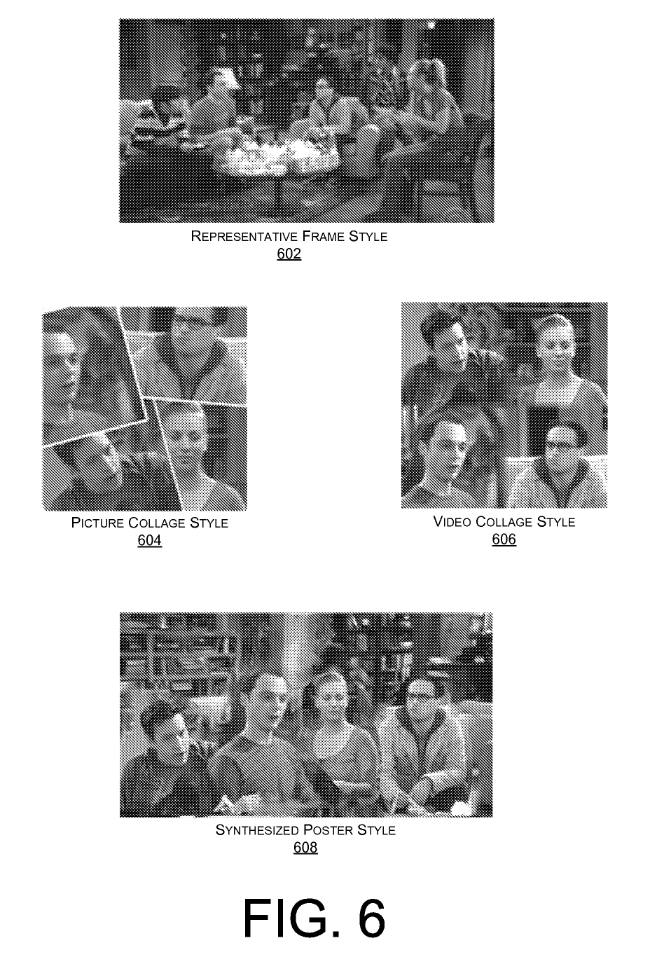

FIG. 6 illustrates example user interface (UI) presentations in the form of posters created by the generation application 114, for example as embodied by the generation tool 218 using key-role acquisitions from a video. Key roles and their relationships, such as those discovered by the community graph 216, provide a basis for a wide variety of applications. For example, visual summaries or video posters may be generated based on acquired key roles. FIG. 6 illustrates four different styles of poster visualizations based on the example community graph 500. As described herein, visual summaries and video posters include static previews, including either an existing image or a synthesized image of video content.

In the video domain, content includes movies, television programs, music videos, and personal videos, as well as movie series and television series. Digital or printed posters with graphical images and often containing text are designed to promote the video content. Promotional posters serve the purpose of attracting the attention of the possible audiences as well as revealing key information about the content to entice the potential audience to view the video.

The generation tool 218 automatically creates a presentation or poster containing identified key roles such as selected from one of the community graphs 216 or 500. The key roles will generally appear frequently in the video and have many interactions with other roles in the video.

The generation tool 218 identifies nodes/vertices that contain the most frequently captured faces with edges to other vertices having a correlation weight meeting a minimum or configurable threshold. The generation tool 218 employs a role importance function f(v) on a vertex v where FaceNum(v) denotes the number of faces in the cluster represented by vertex v and Degree(v) is the degree of the vertex v in the community graph, e.g., the sum of the weight of the edges connected to v. The terms FaceNum(v) and Degree(v) may be in different levels of granularity. Thus, the generation tool 218 employs λ̅=num of faces/Σᵥ Degree(v) to balance these two terms in the role importance function presented as equation 6, below.

f(v)=FaceNum(v)+λ λ̅Degree(v) (6)

Various implementations of the generation tool 218 are configurable to select a number or percentage of roles with the largest f(v) as the key roles for presentation. For example, the 3-5 roles with the largest f(v) may be selected, roles with an f(v) above a threshold may be selected, or the roles with the top 25% of the calculated f(v) may be selected. In at least one embodiment, the roles selected may be based on an organic separation, that is a natural breaking point where there is a noticeably larger separation between the f(v) values in the range of f(v) represented by the community graph 216.

FIG. 6, at 602, illustrates a representative frame style poster. To create this style of poster, the generation tool 218 selects a key frame that contains key roles. For example key frames in contention to be selected may be the key frames containing the most key roles or key frames containing a number of key roles above a configurable threshold. The generation tool 218 also quantifies one or more of how well the contending key frame represents the entire video in terms of color and/or theme as well as the visual quality of the contending key frame, including whether the frame and the characters contained therein are “in-focus.”

The generation tool 218 employs a representation function r(fᵢ) on each contending key frame fᵢ and selects the frame with the largest r. Representation function r(fᵢ) is shown in equation 7, below.

$$r ( {f}_{i} ) = {\sum }_{j} \frac{log S ( {f}_{i}^{( j )} )}{\vert h ( {f}_{i} ) - \overline{h} \vert} \qquad ( 7 )$$

In equation 7, j indicates the face index in the frame fᵢ, S(fᵢ^{(j)}) denotes the area of the j-^{th} face, h(fᵢ) indicates the color histogram of key frame fᵢ, and h̅ is the average color histogram of the video. Other features related to video quality are integrated in various implementations.

FIG. 6 illustrates two collage style posters at 604 and 606. To create these styles of poster, the generation tool 218 extracts a representative face image for each key role and employs a collage technique to organize the faces into a visually appealing presentation. The generation tool 218 selects candidate face images using the role importance function f(v) shown in equation 6. In addition, the generation tool 218 selects the number of roles to be included in the collage from the values assigned to nodes by the role importance function f(v) shown in equation 6.

In various implementations, the representative faces extracted from the candidate face images are also extracted based on being front-facing, of acceptable visual quality, e.g., clear as opposed to blurry, and/or not occluded by other characters, scenery, and in some instances clothing such as hats, scarves, or dark-glasses.

The collage technique used by the generation tool 218 to create the picture collage style shown at 604 detects the face region as the region-of-interest (ROI). The generation tool 218 employs the Markov Chain Monte Carlo (MCMC) to assemble a picture collage in which all ROIs are visible while other parts of the image are overlaid. Similarly, after detecting the face region as the ROI, the collage technique used by the generation tool 218 to create the video collage style shown at 606 concatenates the images by smoothing the boundaries to assemble a naturally appealing collage.

FIG. 6 illustrates a synthesized style poster at 608. To create this style of poster, the generation tool 218 seamlessly embeds images of the key roles on a representative background. Thus, the synthesized style poster contains a representative background which introduces typical surroundings and context in addition to prominently featuring key roles to entice potential viewers to watch the video.

To create the synthesized style of poster, the generation tool 218 selects a key frame that contains a representative background and filters out or extracts objects from the background based on character interaction with the objects. In various implementations the generation tool 218 selects the background key frame using a process equivalent to that of selecting a representative frame as a poster as discussed regarding 602 of FIG. 6. However, when selecting a background key frame, the generation tool 218 selects the frame with the smallest r(fᵢ) as defined by equation 7. When selecting a background frame, the generation tool 218 selects a frame in which a minimal number of faces appear, to avoid viewer distraction and to minimize object/face removal processing.

The generation tool 218 seamlessly inserts face images of key roles on the filtered background. In at least one implementation, the position and scale of the face images are based on the size of the corresponding cluster 212 represented by the node in the community graph 216. For example, images from the largest clusters are featured more prominently than those from smaller clusters.

### Example Processes

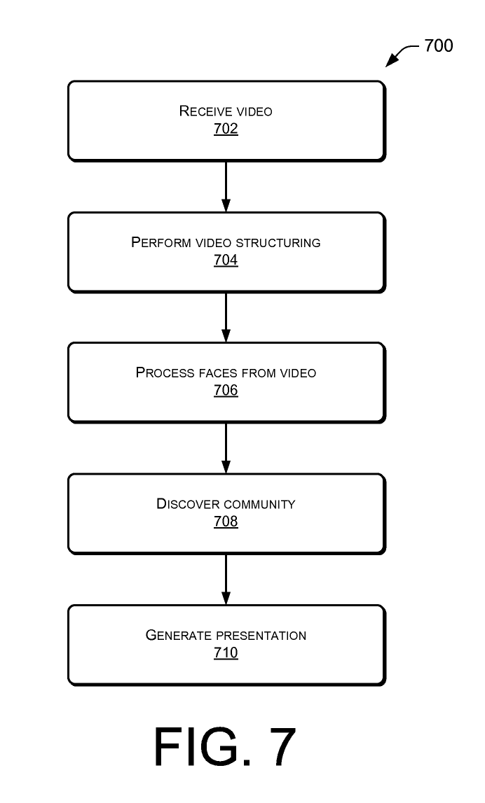

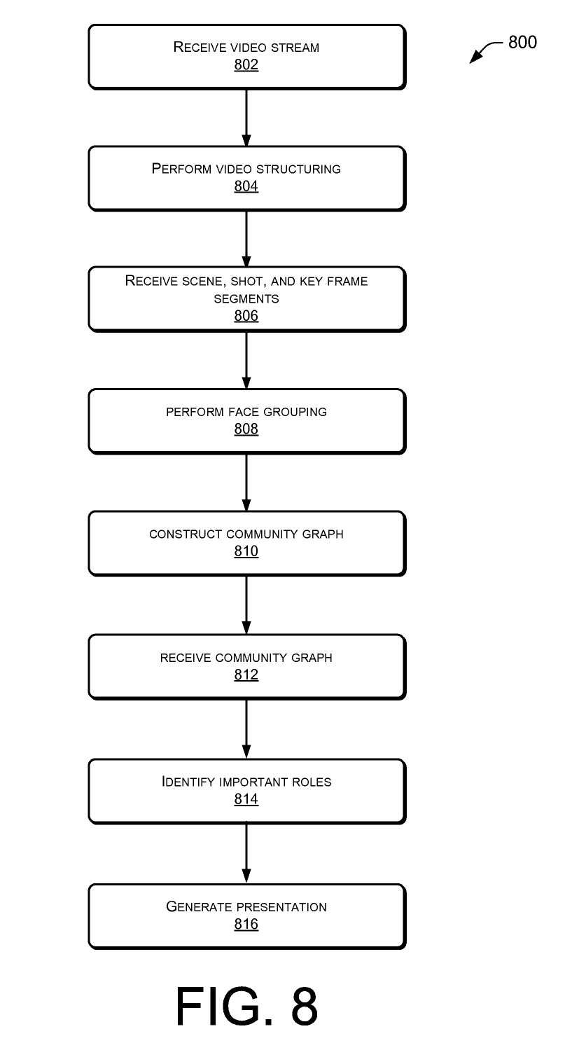

FIGS. 7 and 8 are flow diagrams illustrating example processes 700 and 800 for performing key-role acquisition from video as represented in FIGS. 2-6.

The process 700 (as well as each process described herein) is illustrated as a collection of acts in a logical flow graph, which represents a sequence of operations that can be implemented in hardware, software, or a combination thereof. In the context of software, the blocks represent computer instructions stored on one or more computer-readable media that, when executed by one or more processors, perform the recited operations. Note that the order in which the process is described is not intended to be construed as a limitation, and any number of the described acts can be combined in any order to implement the process, or an alternate process. Additionally, individual blocks may be deleted from the process without departing from the spirit and scope of the subject matter described herein. In various implementations one or more acts of process 700 may be replaced by acts from the other processes described herein.

The process 700, for example, includes, at 702, the video tool 202 receiving a video. For instance the received video may be a video streamed over a network 102 or stored on a computing device 104. At 704, the video tool 202 performs video structuring. For example, the received video is structured by segmenting the video into a hierarchical structure that includes levels for scenes, shots, and key frames. At 706, the video tool 202 processes the faces from the structured video. For instance, faces from the key frames are processed by detecting and grouping. At 708, the video tool 202 discovers a community based on the processed faces. At 710, the video tool 202 automatically generates a presentation of the video based on the discovered community. In several implementations, the presentation is generated without relying on rich metadata such as cast lists, scripts, or crowd-sourced information such as that obtained from the world-wide-web.

The process 800, as another example, includes, at 802, the video tool 202 receiving a video. At 804, the video structuring component 204 hierarchically structures the video into the video structure information 208 including scene, shot, and key frame segments. For instance, the video structuring component 204 may first detect shots as a continuous section of video taken by a single camera, extract a key frame from each shot, and detect similar shots that the video structuring component 204 groups to form a scene. At 806, the community discovery component 214 and the face grouping component 210 receive the scene, shot, and key frame segments. At 808, the face grouping component 210 performs face grouping by detecting faces from the key frames to form the face clusters 212.

At 810, meanwhile, the community discovery component 214 constructs a community graph 216 by identifying nodes (e.g., according to co-occurrence of the roles in a scene) based on the roles represented by the face clusters 212 and the video structure information 208. At 812, the generation tool 218 receives the community graph 216. At 814, the generation tool 218 identifies important roles by using a role importance function such as that shown in equation 6. For instance, the generation tool 218 calculates role importance based on the nodes/vertices of the community graph 216 that contain the most frequently captured faces and have an appropriate number of edges connecting to other nodes/vertices. At 816, the generation tool 218 generates one or more presentations in accordance with those shown in FIG. 6.

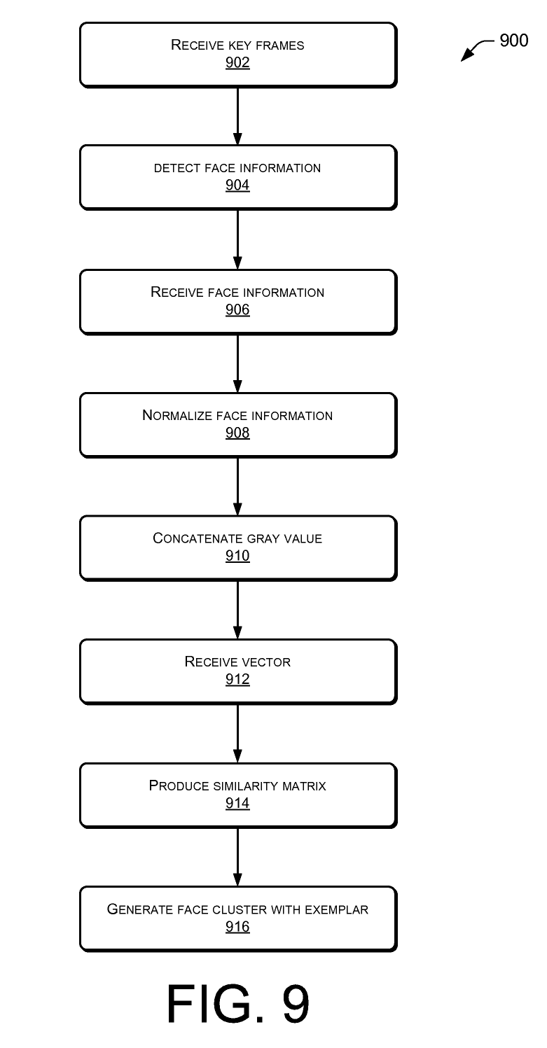

FIG. 9 is a flow diagram of an example process for acquiring key roles via face grouping. The process 900 of FIG. 9 includes, at 902, the face grouping component 210 receiving the key frames 304. At 904, the face detection component 302 detects the face information 306 from the key frames 304. At 906, the feature extraction component 308 receives the detected face information 306. At 908, the face image normalization component 310 normalizes the detected faces into (e.g., 64×64) gray scale images 312. At 910, the feature concatenation component 314 concatenates the gray value of the pixels of the gray scale images 312 as a 4096-dimensional vector 316, in some instances. At 912, the face descriptor component 318 receives the vector 316. At 914, the distance matrix component 320 produces a similarity matrix 322 by comparing received vectors using learning-based encoding and principal component analysis (LE-PCA). At 916, the clustering component 324 generates face clusters, like face cluster 212, and selects an exemplar 326 for each cluster.

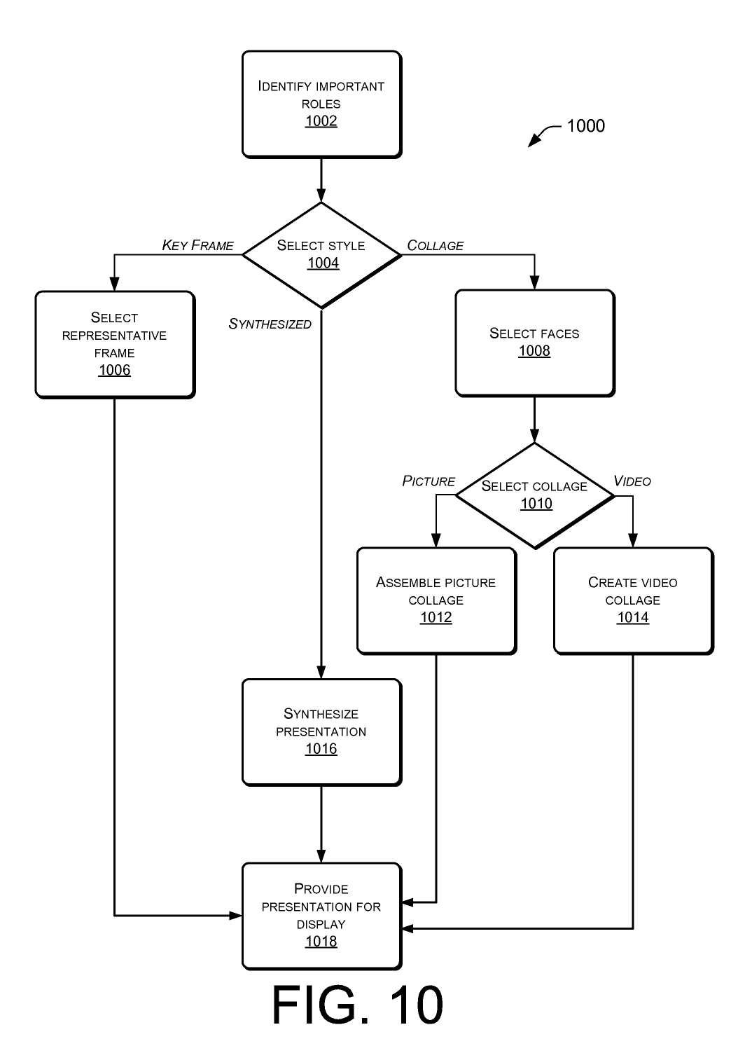

FIG. 10 is a flow diagram of an example process employing key-role acquisition from video to generate a presentation. The process 1000 of FIG. 10 illustrates the generation tool 218 automatically creating a presentation or poster containing identified key roles selected from a community graph such as the community graphs 216 or 500.

At 1002, the generation tool 218 identifies nodes/vertices containing the most-frequently captured faces and that have edges to other vertices with a correlation weight meeting a minimum threshold by using a role importance function. For instance, the generation tool 218 may use a role importance function such as that shown in equation 6 to identify the desired nodes/vertices.

At 1004, the generation tool 218 selects one or more presentation styles for generation. At 1006, when the generation tool 218 selects a key frame style presentation such as the example shown at 602, a representative frame containing key roles is selected as the presentation by using a representation function such as that shown in equation 7. At 1008, when the generation tool 218 selects a collage style presentation, such as the picture collage style example shown at 604 or a video collage style example shown at 606, the generation tool 218 selects candidate face images by using a role importance function. In some instances, the generation tool 218 uses a role importance function, such as that shown in equation 6 to select candidate face images.

At 1010, processing for the two example collage styles diverges. At 1012, when the generation tool 218 selects a picture collage style presentation, the generation tool 218 assembles a picture collage in which each face region-of-interest is visible, while other parts of the face images are overlaid. At 1014, when the generation tool 218 selects a video collage style presentation, the generation tool 218 creates a video collage by detecting the face regions-of-interest and concatenating the images with smoothed boundaries to assemble a naturally appealing collage.

At 1016, when the generation tool 218 selects a synthesized style presentation such as the example shown at 608, the generation tool 218 synthesizes a presentation by embedding images of the key roles on a representative background. For example, the representative background frame with the smallest r(fᵢ) as defined by equation 7 is selected. To complete the synthesized style presentation, the generation tool 218 embeds face images of identified key roles on the filtered background.

At 1018, the generation tool 218 provides the selected presentation styles for display. In various implementations, the presentations are displayed electronically, e.g., on a computer screen or digital billboard, although the presentations may also be provided for use in print media.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

What is claimed is:

1. A method comprising:
receiving a video from which to identify key roles;
performing video structuring on the video to obtain a structured video;
processing faces from the structured video;
discovering a community from the processed faces;
identifying the key roles and relationships between the key roles from the community; and
generating a presentation that depicts the key roles that has been acquired.

2. A method as recited in claim 1, wherein the identifying of the key role is performed independent of using metadata associated with the video.

3. A method as recited in claim 1, wherein the video includes internet protocol television (IPTV) content or video on demand (VOD) content.

4. A method as recited in claim 1, wherein the video structuring includes:
extracting a shot from the video;
identifying a key frame in the shot; and
grouping a plurality of shots to form a scene; and
wherein the presentation at least partly depicts the scene.

5. A method as recited in claim 1, wherein the processing of the faces from the structured video includes determining an importance of a role associated with at least one of the faces, and wherein the presentation is generated based at least in part on the importance of the role associated with the at least one face.

6. A method as recited in claim 1, wherein the discovering the community from the processed faces includes constructing a community graph representing interrelationships between roles associated with the faces.

7. A method as recited in 6, wherein the community graph further represents strengths between the interrelationships between the roles.

8. A method as recited in claim 1, wherein the presentation being generated includes a key frame style presentation being based at least on a key frame representing the video in terms of one or more of color, theme, or visual quality.

9. A method as recited in claim 1, wherein the presentation being generated includes multiple pictures arranged in a collage.

10. A method as recited in claim 1, wherein the presentation being generated includes images of key roles embedded on a representative background.

11. A computer-readable medium having encoded thereon computer-executable instructions to configure a computer to perform operations comprising:
receiving a video from which to ascertain a key role;
processing faces from the video to obtain processed faces;
discovering a community from the processed faces;
ascertaining the key role from the video based at least on the community; and
generating a presentation that includes the key role that has been ascertained.

12. A computer-readable medium as recited in claim 11, wherein the processing faces from the video includes determining an importance of a role associated with at least one of the faces, and wherein the presentation is generated based at least in part on the importance of the role associated with the at least one face.

13. A computer-readable medium as recited in claim 11, wherein the ascertaining the key role from the video is performed independent of metadata associated with the video.

14. A computer-readable medium as recited in claim 11, wherein the discovering the community from the processed faces includes:
identifying faces most frequently processed from the received video and having a threshold level of relationships to other faces being processed; and
employing the faces being identified as vertices to construct a community graph including correlations between the processed faces.

15. A computer-readable medium as recited in claim 11, wherein the presentation being generated includes a presentation being synthesized from at least one key frame and at least one key role, and wherein an image of the at least one key role is embedded on a representative background obtained from the at least one key frame.

16. A computer-readable medium as recited in claim 11, further comprising instructions to configure the computer to perform operations comprising:
extracting a shot from the video;
and identifying a key frame in the shot.

17. An apparatus comprising:
a processor;
a video tool configured to receive video;
a face grouping component configured to generate a face cluster for faces identified in the video; and
a generation tool configured to generate a presentation based at least on a key role identified from the face cluster being generated.

18. An apparatus as recited in claim 17, wherein the video tool identifies the key role independent of metadata associated with the video.

19. An apparatus as recited in claim 17, wherein the generation tool is configured to generate the presentation based at least on a community discovered by constructing a community graph representing interrelationships between a plurality of key roles represented by a plurality of face clusters.

20. An apparatus as recited in claim 17, wherein the generation tool is configured to generate the presentation based at least on determining an importance of the key role represented by the face cluster, and wherein the presentation is generated based at least in part on the importance of the key role.
